(19) United States
(12) Patent Application Publication
(10) Pub. No.: US 2016/0012216 A1
(43) Pub. Date: Jan. 14, 2016

(54) SYSTEM FOR POLICY-MANAGED SECURE AUTHENTICATION AND SECURE AUTHORIZATION

(71) Applicant: Sequitur Labs Inc., Issaquah, WA (US)

(72) Inventors: Philip Attfield, Fall City, WA (US); Daniel Schaffner, Seattle, WA (US)

(21) Appl. No.: 14/675,044

(22) Filed: Mar. 31, 2015

Related U.S. Application Data
(60) Provisional application No. 61/978,075, filed on Apr. 10, 2014.

(51) Int. Cl. G06F 21/31; G06F 21/62; G06Q 30/02; G06F 21/32

(52) U.S. Cl. CPC G06F 21/31; G06F 21/32; G06F 21/6245; G06Q 30/0251

(57) ABSTRACT

A system for policy-managed, secure authentication and authorization for transactions. The present invention links identification and verification methods and apparatus to a policy-managed system that can control how such devices are utilized under specific scenarios as defined by the policy maker. The system then approves or denies the transaction and may also direct further action if specified in the policy rules. The user identification device and the policy-manager need not be collocated. The resulting system is advantageous because of its increased flexibility in providing secure authorizations where greater control is desired. Also, the processing of these transactions facilitates detailed records that are useful in tracking transactions or to advertisers and merchants wishing to target specific markets for their products.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

The present invention relates generally to secure transactions, telecommunications, digital communications, computer security, computer technology, and mobile computing.

### BACKGROUND OF THE INVENTION

In the past two decades, there has been tremendous growth in the use of digitally-based authentication and authorization methods. These span systems such as simple user name and password authentication as a basis for access to various online services, through to various electronic means of performing credit card and debit card transaction authorization, and other transaction authorization.

User authentication may be single-factor, requiring a single identifying item from a user, such as a password, or multiple factor, requiring two or more identifying items (physical and/or digital) from the user. The two-factor authentication case is especially common for transaction authorization purposes, requiring, for example, both the demonstrated possession of a physical asset such as a numbered card (credit or debit card) and submission of an access code such as a multi-digit access number or “personal information number” (PIN). Such cards may contain one or more of magnetic stripes and machine-readable integrated circuit “chips” on which are stored the card number and, potentially, other information.

Recently, inexpensive “chip and PIN” devices have become available as commercial products, from companies such as Square Inc. (https://squareup.com) and Payleven Co. (https://payleven.co.uk), alongside software application- and service-supported chip and PIN payment processing by companies such as iZettle AB (http://izettle.com). These multi-factor devices are able to read the on-card chips, and also to receive, typically via an onboard or attached keypad, a PIN entered by a user.

In a slightly different case for iZettle, the PIN may be entered through an application running on a mobile device or PC or other internet-connected device. The received information read from the chip, and the entered PIN, are typically then communicated via some secure, encrypted means, to a processing system such as a transaction authorizing or payment acceptance and processing system. Other information such as customer- and vendor-identifying information, plus details of a corresponding purchase and total requested payment amount may also be communicated to the processing system by various means.

Macro-level policy rules can be applied in the case of financial transactions. For example, major credit cards may provide a service for corporate customers who want their employees to have a corporate credit card but who wish to limit the use of the corporate card. In this example, an employee may be allowed to pay for hotel and rental car when traveling, but may not pay for entertainment per corporate policy. However, this policy is set at a macro level that is extremely limited in terms of context at the point of sale and is also not individualized to the user but rather to a class of users or to the corporation itself. At the macro level, the policy is neither dynamic nor granular.

The key shortcoming of state of the art “chip and PIN” devices for authentication and authorization is that they are largely limited to functions regarding verification of the user/possessor of the card. The context of the transaction is not known to the card, therefore information about the transaction cannot be used in authorizing the transaction. The present invention addresses this shortcoming resulting in a micro-level dynamic and granular policy-managed environment that can be tailored to the individual user and scenario.

### BRIEF SUMMARY OF THE INVENTION

Current solutions to personal identification and verification lack any knowledge of the context of the transaction or need for verification and therefore are limited in scope to only identifying and authenticating the user. The present invention addresses this limitation by linking identification and verification methods and apparatus to a policy-managed system that can control how such devices are utilized under specific scenarios as defined by the policy author.

The technical problem lies in how the context sensitive policy-managed system is linked to the identification and authentication method. Simply adding policy control after authentication is inadequate because it does not allow the policy rules to consider who the user may be and what he/she is allowed to do in that scenario.

The present invention solves this problem by providing an interface between the chip and PIN reader and the policy-managed system that allows the policy-managed system to secure an authorization at the point of transaction that includes all information regarding the identity of the user and the nature of the transaction. The policy-managed system may reside locally or remotely via a service.

The resulting system is advantageous because of its far increased flexibility in providing secure authorizations where greater granularity of control is desired. Also, the processing of these transactions easily facilitates detailed records that are useful in tracking transactions or to advertisers and merchants wishing to target specific markets for their products.

### BRIEF DESCRIPTION OF THE DRAWINGS

FIG. 1 is a flowchart of communication routes and sequence for policy-based chip and PIN reader transaction control system.

FIG. 2 is a potential physical layout of system for policy-managed secure authentication and secure authorization.

### DETAILED DESCRIPTION OF THE INVENTION

The present invention is a secure, policy-managed system that supports the secure use of chip and PIN devices in specific ways, including methods for secure data protection, and further, can be used to control and manage how data from such devices can be utilized for secure authentication and authorization purposes in certain scenarios.

First, the use of chip and PIN devices in commerce generally requires adherence to rigorous sets of rules or policies governing details of allowable transactions, authorized vendors and buyers, as well as the details of the devices themselves and their permissible usage. In the present invention, a policy-based access control and management system is used to describe such sets of rules, and based on these rules and input parameters such as data from chip and PIN, to compute decisions on whether a given requested transaction should be allowed or disallowed, and potentially, also to take actions or direct specific actions to be taken based on these decisions. One such policy-based system that could be utilized to perform the required policy processing and certain enforcement functions is that presented in international patent application PCT/US13/78004 ('004) the disclosure of which is included by reference as if fully set forth herein.

While there are many rules that may need to be considered in such policy-based decision making associated with user authentication, the following is a non-limiting list of a few such rules for illustrative purposes:
The chip reader device must be registered with an acceptable authority.
The vendor is an authorized vendor and is a permitted host of the reader device.
The PIN entered by the client is correct.
The client's account associated with the card must be in good standing (e.g., with an external authority such as an issuer, or third party fraud monitoring service).
The originating location and other geo-specific details of the transaction request are allowed (e.g. requests originating in Sweden are allowed, but not those originating in Russia).
The client's account balance or credit limit exceeds the requested transaction amount.

These and other rules may then be analyzed with use of the available input data to compute a decision for the requested transaction, including a course of action such as processing the transaction, or even invalidating the received card or the reader device if suspicious input data is received.

The invention can utilize any type of chip and PIN reader or any other user validation apparatus that is used to validate that the holder of the card or device is who he or she portends to be. But, rather than validate the transaction based only on user verification, the present invention “interrupts” the authorization process to include further processing. The policy-managed system may reside locally at the point of transaction or may reside remotely accessed via a service across the network. The point of transaction can be a check-out at a physical store or place of business or can also be an e-retailer check-out via a web page. In all cases, the user verification of the chip and PIN device is coupled to the policy rules of the policy-managed system resulting in a secure authorization (approval or denial).

It is notable that significant confidential data, such as the PIN, personal user data, and transaction and account information is typically to be considered in evaluating policy decisions. A recent development has been the development of secure environments (SEs) for storing such sensitive data, and for executing programs that process it. One such secure environment is the Trusted Execution Environment (TEE) specified at http://www.globalplatform.org/, in which only trusted applications may access and act on the sensitive data, and the data is otherwise inaccessible and not vulnerable to exploitation by untrusted applications.

In a variant on the invention, the sensitive data storage and the policy decision analysis can be performed in such a secure environment as TEE or similar. In such a scenario, multiple trusted applications can be allowed to share data and decisions between each other. For example, the policy decision system may decide to allow a transaction that represents payment for use of a third party software application. The third party application in this manner sees only the decision outcome, and need never directly access or compromise sensitive personal data. This allows for inter-application payments in which the third party application effectively debits a card-associated account without itself directly accessing sensitive data.

It is further notable that such a decision processing system, coupled with transaction request data, will obtain substantial information on customer purchasing habits and customer profiles for purchase of specific products. The logs of such a system as presented for our invention, are expected to be valuable to product sellers, for example in future advertising and targeted marketing. These logs will be substantial and therefore suitable for processing in “cloud” or “big data” environments, preferably in anonymous form. In addition, characteristics of such transaction histories may be used in the policy based decisions themselves (e.g., prevent the transaction if there is a sudden uptick in frequency of transactions compared to historical norms for that transactor). Lastly, this same transaction data will be useful to the customer particularly for tracking business expenses, trends, or abuses of policy that could result in revision of corporate transaction policy.

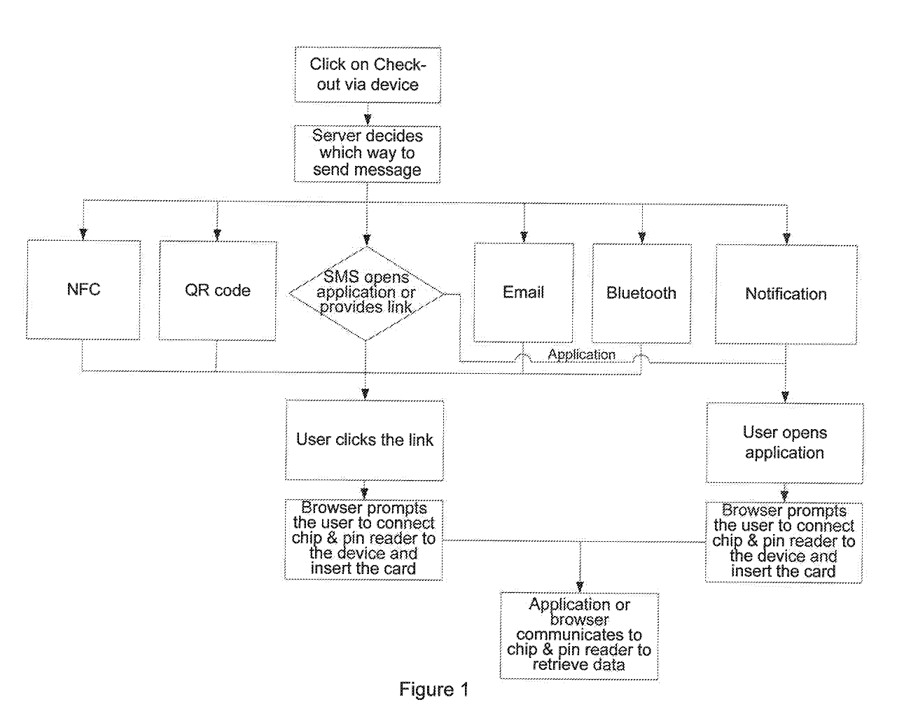

In a further embodiment of the invention, the same chip and PIN security discussed previously can also be coupled to website transactions. In this case, each customer using the system has, or has access to, a chip and PIN device with a keypad, or a simple chip reader plus a separate means of PIN entry such as secure website. The chip device may be connected to the browsing device via USB, may be integrated into the keyboard or via other means. FIG. 1 illustrates in flow chart form how such a system might operate, using a variety of means of communication. Such a system can operate in different ways depending on whether or not the card reader has an integrated PIN display/capture interface (or if such an interface is provided but not used).

In FIG. 1, when the user “checks out” signifying that he/she wants to complete the transaction, the system can use a variety of different messaging techniques to connect the user authentication system (e.g. chip and PIN reader) to the policy-managed system. A non-limiting set of messaging methods includes Near Field Communications (NFC), Quick Response codes, E-Mail, Bluetooth, or other notification means. The user is then prompted to use the chip and PIN reader or other authentication device while connected to the policy-managed service. Now, information about user identity and context of the transaction are all available to the policy-managed service for processing and evaluation.

Here the communication channel is considered to be untrustworthy, so with reference to the previously described secure environment (SE) use, here the system could use SE and a trusted user interface (TUI), potentially with encryption methods as needed, to secure an untrustworthy channel between endpoints of the chip+pin reader/card, backend system and credentials/UI on the device.

Also, some chip and PIN readers employ audio as the communication channel. In such a case, an application or service on device acts primarily as a conversion interface (converting audio to a stream of bits) and event router and trigger, plus user interface and handshaking with backend services, web server, TUI/SE. The application itself does not have to be trustworthy because transactions, PIN, content, and potentially other supplementary data are secured by base material located within the SE, on the chipped card and in backend services. Other alternatives such as USB may be utilized in place of audio as the channel, but the same principles apply, potentially with the exception of the audio-data conversion.

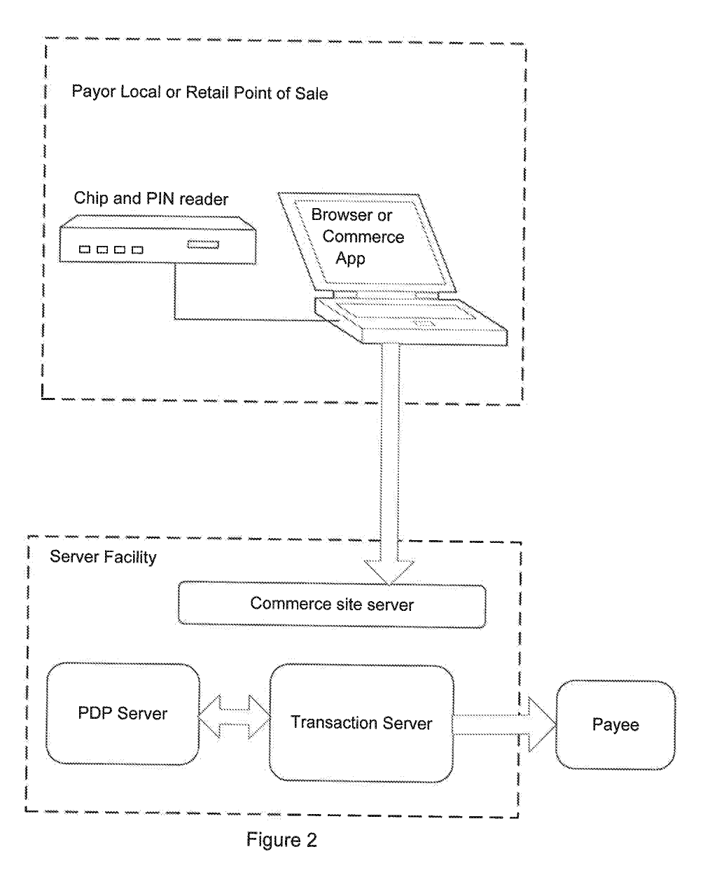

FIG. 2 illustrates schematically one potential physical layout of an implementation of the invention. Regarding FIG. 2, in some cases, the component locations may coincide, and other physical details may otherwise differ from this illustration. As examples, the retail point of sale and server and PDP (Policy Decision Point) may reside in the same premises, or the commerce site web server, PDP and transaction processing server may reside in separate locations. Furthermore, network connectivity and communications paths can be implemented differently than shown; transaction requests may go directly from the payee computer to the transaction server, rather than be routed through the commerce server as shown.

While the system and techniques described herein are notably applicable to systems employing chip and PIN devices, it is also the case that much of what is described can be applied to other areas of device-based authentication and authorization, such as those using other factors than chips and PINs in multi-factor authentication systems. Neither the description nor the examples used in this application should be taken as limiting the generality or the applicability of the system and the techniques presented to chip and PIN reader devices specifically, although they are immediately applicable in those areas.

### INDUSTRIAL APPLICATION

The invention applies most generally to commerce, both e-commerce that may occur at remote locations via a web browser or other network enabled applications and also retail commerce where transactions occur on site. However, it is not limited to commerce because it applies to any application where the identity of the user and the context of the action to be taken is critical. For example, a service representative for a company needs access to a remote system to perform maintenance. He uses the invention to use his chip and PIN reader at the remote site to verify himself and requests access to data he needs for a specific purpose. The policy-managed system either grants or denies access based on his identity and the context of his request.

Furthermore, within the context of commerce, the invention naturally lends itself to data capture that is not possible without the invention. Companies that wish to track the transaction activities of employees for record keeping or other purposes will have access to that data. The same data is also useful for revising the policy rules for that company. Finally, individual data per user or aggregated across classes of users or companies could be used for advertising or targeted marketing that specifically addresses the types of products and services that a user, class of user, or company is interested in.

What is claimed is:

1. A system for policy-managed, secure personal authentication for transactions comprising:
a personal identification device for verifying the user's identity;
a policy-management subsystem for validating a transaction based on the identity of the user and the context of the transaction;
an identity interface that connects the personal identification device to the policy-management subsystem for accepting user authentication and contextual information regarding the transaction; and
a communication subsystem for transmission of the validation decision that includes any associated direction for action.

2. The system of claim 1 wherein the personal identification device is one of:
a chip and PIN reader;
a biometric identity subsystem that includes one or more of;
a fingerprint scanner;
a voice identification system;
a facial recognition device; and
a retinal scanner; and
a multi-factor identity system that combines multiple identity systems into a single authentication.

3. The system of claim 1 wherein the policy-management subsystem includes;
a secure computing environment that protects confidential personal and transaction information from exposure to other parties;
a set of policies that describe the validity of transactions; and
a communication subsystem for transmission of the validation decision that includes;
an approval or denial response; and
directions to take specific actions based on the validation decision.

4. The system of claim 1 wherein the identity interface includes;
Near Field Communications (NFC);
Quick Response codes;
E-Mail;
Bluetooth;
explicit notification via the network; and
direct connection.

5. The system of claim 1, wherein the personal identification device and the policy management system reside on the same computing hardware with direct hardware connection between them.

6. The system of claim 1, wherein, the personal identification device and the policy management system reside on remote computing hardware with a networked connection between them.

7. The system of claim 1, wherein a transaction originates from an e-commerce site on the Internet and the user is authenticated locally with a personal identification device.

8. The system of claim 1, wherein transaction data is retained in a log or secure database for analytical processing.

9. The system of claim 8, wherein the transaction data is used for targeted marketing or advertising.

10. A method for policy-managed, secure personal authentication for transactions comprising the steps of;
validating the identity of a user via a personal identification device;
connecting the personal identification device to a policy-manager;
validating the transaction based on the identity of the user and in the context of the transaction using the policy rules in the policy manager; and
transmitting the result of the validation decision with associated direction for further actions back to the requestor.
